(19) United States
(12) Patent Application Publication
(10) Pub. No.: US 2022/0264856 A1
(43) Pub. Date: Aug. 25, 2022

(54) FISHING LURE THAT MIMICS A DECAPOD CRUSTACEAN

(71) Applicant: LIVE LURES LLC, LAWRENCEVILLE, GA (US)

(72) Inventor: JOSEPH MALOOLEY, LAWRENCEVILLE, GA (US)

(73) Assignee: LIVE LURES LLC, LAWRENCEVILLE, GA (US)

(21) Appl. No.: 17/744,305

(22) Filed: May 13, 2022

Related U.S. Application Data
(63) Continuation-in-part of application No. 17/729,724, filed on Apr. 26, 2022.
Application No. 17/729,724 is a continuation of application No. 16/728,531, filed on Dec. 27, 2019, now Pat. No. 11,337,410.
(60) Provisional application No. 62/749,949, filed on Oct. 24, 2018.

(51) Int. Cl. A01K 83/06; A01K 91/04

(52) U.S. Cl. CPC A01K 83/06; A01K 91/04

(57) ABSTRACT

A fishing lure system configured to generate a movement that mimics the lifelike movement of a decapod crustacean is provided. By sequentially applying and releasing a pulling force on a fishing line fixed to the fishing lure system, the entire system may be pulled in the direction of the force while a tail portion of the lure is “kicked” forward in a direction opposite to the pulling force.

### CROSS-REFERENCE TO RELATED APPLICATIONS

This application is a continuation-in-part of U.S. application for patent Ser. No. 17/729,724 entitled FISH HOOK APPARATUS, filed on Apr. 26, 2022 in association with attorney docket number 12075.101002, which is a continuation of U.S. application for patent Ser. No. 16/728,531 entitled FISH HOOK APPARATUS, filed on Dec. 27, 2019 and claiming priority to and the benefit of the provisional patent application entitled “Curlin' Worm”, Application No. 62/749,949, filed in the United States Patent and Trademark Office on Oct. 24, 2018. The above referenced patent applications are hereby incorporated herein by reference in their entireties.

### BACKGROUND

### Technical Field

The embodiments herein, in general, relate to fishing devices or lures. More particularly, the embodiments herein relate to a fish hook apparatus or fishing lure configured to produce a controllable action in a bait during fishing, such as to mimic the look and movement of a worm in some embodiments or a decapod crustacean in other embodiments.

### Description of the Related Art

A fish hook is a device for catching fish by piercing the mouth of the fish or capturing the body of the fish. A person who fishes, also referred to as an “angler,” typically uses a fishing bait or a fishing lure for attracting the attention of the fish. The fishing bait typically uses color, movement, vibration, etc., to attract or bait the fish. Some fishing baits comprise one or more hooks for catching the fish when the fish strikes the fishing bait. Most fishing baits are tied off with a fishing line at the head of the fishing bait (usually tantamount to tying off to the hook itself) and pulled through the water back to the angler via a fishing reel of a fishing rod. “Action” is imparted to the lure by jerking, twitching, or just moving the rod tip while, or in conjunction with, reeling in fishing line with the reel. The movement of pulling a fishing bait through the water (via reeling and/or manipulating the rod tip) provides the fishing bait its action for attracting the fish. Generally speaking, the more lifelike and real the action of the lure seems to a fish, the more likely that the angler will be successful in enticing the fish to take the bait. As such, a lifelike or natural movement is a highly desirable feature for fishing lures.

The head of the fishing bait typically comprises a metal loop, herein referred to as an “eye” or “eyelet,” to which the fishing line is tied. As such, an aggressive movement of the rod tip will “set the hook” in a fish that has attacked the lure because the aggressive movement works to quickly pull the hook to which the line is tied. In the prior art, the need to tie a fishing line to an eyelet associated directly with a hook (or hooks) makes it difficult for a fisherman to cause the lure to imitate lifelike movement when being presented to a fish. And so, prior art fishing lures do not always provide an angler with sufficient control over the movement of the fishing bait in a strike zone of the water.

Moreover, regarding fishing lures intended to imitate decapod crustaceans, such as crawfish or shrimp or prawns or lobsters, prior art fishing lures have been largely unsuccessful in imitating or mimicking the movement of a decapod crustacean. As one of ordinary skill in the art would recognize, a decapod crustacean moves through its environment “backwards” (tail first, head last) by generating propulsion with its tail. In this way, the tail of a decapod crustacean “kicks forward” (toward the head of the crustacean) while the whole body of the crustancean is propelled through the water “backwards.” Recreating these opposite, yet simultaneous, movements in order to present a lifelike action in a lure meant to mimick a decapod crustacean has proved difficult in the prior art.

Similarly, prior art fishing lures have had difficulty imitating or mimicking the lifelike movement of a worm that has fallen into water. As one of ordinary skill in the art would recognize, a worm that has fallen into water will “wiggle” and “thrash” around with the tail and head of the worm simultaneously moving toward and away from one another without the worm being moved through the water (worms don't really “swim” through water). Because prior art solutions tie the fishing line directly to the hook eyelet, recreating such lifelike movement is nearly impossible. Consequently, prior art solutions for fishing lures meant to imitate a worm rely on pulling the lure through the water such that passing water provides a motive force to generate action from the lure body (such as a flexible and curled tail), the unfortunate tradeoff being that the worm lure is presented to a fish as swimming through the water (a demonstrably unnatural, and therefore unconvincing, movement for a lure meant to imitate a worm).

Hence, there is a long-felt need for a fish hook apparatus and a method for producing a controllable action, for example, a curling, worm-like action, in a bait during fishing. Moreover, there is a need for a fish hook apparatus and a method that allow an angler to create and control the action in the bait with minimal effort and without having to reel in the bait. And further, there is a need in the art for lures configured to generate lifelike movements meant to imitate worms and decapod crustaceans.

### SUMMARY

This summary is provided to introduce a selection of concepts in a simplified form that are further disclosed in the detailed description. This summary is not intended to determine the scope of the claimed subject matter.

The fish hook apparatus and the methods disclosed herein address the above-recited needs in the art for producing a controllable action such as, for example, a curling, worm-like action, in a bait during fishing. The embodiments of the solution disclosed herein allow an angler to create and control the action in the bait in a manner that accurately mimics lifelike and natural movement.

An embodiment of the solution disclosed herein comprises a head member, a shank, a bend section, a point element, and securing elements. The head member is defined by a top nose element, opposing side walls, and a bottom end. The head member comprises a channel configured to pass through the head member from the top nose element to one of the opposing side walls of the head member. The channel of the head member comprises a first opening and a second opening. The first opening is configured at the top nose element. The first opening is configured to receive a fishing line and pass the fishing line through the channel and out through the second opening. The second opening is configured at the opposing side wall. The second opening is configured to receive and exit the fishing line passed through the channel. The shank extends from the other opposing side wall of the head member. The bend section extends from the shank. The point element extends from the bend section. The point element is configured to pierce a bait. The bait comprises a head, a body, and a tail.

A first securing element, for example, a screw-type fastener such as a screw-type hitchhiker, is coupled to the bottom end of the head member. The first securing element is configured to secure a head of the bait. A second securing element, for example, a hook, is coupled to any one of multiple locations, for example, the body, the tail, etc., of the bait. The second securing element is configured to secure one end of the fishing line exiting from the second opening of the channel of the head member to the bait. The fish hook apparatus disclosed herein allows an angler to controllably tug the fishing line to curl the bait secured by the first securing element and the second securing element backwards towards the head member and to spring the bait forwards due to tension in the bait to produce a controllable action, for example, a curling, worm-like action, in the bait. The fish hook apparatus disclosed herein allows the angler to produce a controllable action in the bait in a strike zone of a water body without reeling the bait out of the strike zone.

In another exemplary embodiment of the solution, a fishing lure system according to the solution comprises a soft bait component defining a head end, a body portion, and a tail end. The soft bait component may be comprised of a soft plastic, a hard plastic, or a combination thereof. The tail end is configured to transition between an extended state and a curled state such that when the tail end is transitioned to the curled state a distal-most portion of the tail end moves toward the head end (like that of a swimming decapod crustacean). The tail end includes a vertical channel defined by an upper aperture associated with an upper surface of the tail end and a lower aperture associated with a lower surface of the tail end. The apertures may include, and be defined by, a grommet(s). A hook component comprising an eyelet, a shank, a bend section, and a point element is mated to the soft bait component such that the shank of the hook component is received into a shank channel on the underside of the soft bait component and retained there by at least a shank retention aspect such as a bridge across the shank channel. Once mated to the soft bait component, the eyelet of the hook component is substantially aligned with the vertical channel through the tail end. A securing element also comprising an eyelet is attached to the underside/lower surface of the tail end of the soft bait component. The diameter of the securing element eyelet may exceed a diameter of the hook component eyelet. Advantageously, when the securing element is secured to the lower surface of the tail end of the soft bait component, and when a fishing line is extended through the vertical channel from the upper aperture to the lower aperture and secured to the eyelet of the securing element, a pulling force applied to the fishing line by an angler will cause the tail end to transition from the extended state to the curled state while the entire fishing lure system is pulled in a direction toward the angler. Conversely, and advantageously, release of the pulling force will allow the tail end to transition from the curled state back to the extended state. In this way, by serially applying a pulling force and letting off of the pulling force, the lure system may be pulled through the water in a first direction as the tail of the lure is “kicked” in a direction opposite to the first direction.

More to the above, an aggressive pulling force applied to the fishing line will cause the securing element eyelet to be received by, and mechanically stopped by, the lower aperture and/or the hook component eyelet. In this way, the hook of the fishing lure may be “set” into a fish that has struck the bait, as would be understood by one of ordinary skill in the art of fishing. The hook component may comprise two or more point elements. It is envisioned that the soft bait component of the exemplary embodiment may be configured to resemble a decapod crustacean such as, but not limited to, a crayfish, a shrimp, a prawn, or a lobster. The soft bait component may further comprise a gas-filled chamber for creating buoyancy and, in some embodiments, the amount of gas in the gas-filled chamber may be adjustable. The soft bait component may also comprise a weight component for causing the system to have an overall density greater than water. It is envisioned that the weight may be comprised of one or more of lead, tin, tungsten, bismuth, steel, and a metal alloy. And, in some embodiments, the soft bait component may comprise both a gas-filled chamber and a weight component, calibrated and balanced to deliver a predictable and controlled descent in water. Additionally, certain embodiments may also include a a scent chamber in the soft bait component for containing a releasable scent substance.

The securing element may be integral to the tail end of the soft bait component or, in some embodiments, the securing element may be removably fixed to the tail end of the soft bait component. For those embodiments that comprise a removably fixed securing element, the securing element may include a corkscrew-type fastener for screwing into the tail end.

### BRIEF DESCRIPTION OF THE DRAWINGS

The foregoing summary, as well as the following detailed description, is better understood when read in conjunction with the accompanying drawings. For illustrating the embodiments herein, exemplary constructions of the embodiments are shown in the drawings. However, the embodiments herein are not limited to the specific structures and methods disclosed herein. The description of a structure or a method step referenced by a numeral in a drawing is applicable to the description of that structure or that method step shown by that same numeral in any subsequent drawing herein.

In the drawings, like reference numerals refer to like parts throughout the various views unless otherwise indicated. For reference numerals with letter character designations such as “102A” or “102B”, or “102L” or “102R,” the letter character designations may differentiate two like parts or elements present in the same figure. Letter character designations for reference numerals may be omitted when it is intended that a reference numeral to encompass all parts having the same reference numeral in all figures.

FIG. 1 illustrates a front elevation view of an exemplary fish hook apparatus, according to an embodiment herein;

FIG. 2 illustrates a front perspective view of the fish hook apparatus of FIG. 1, showing a channel configured to pass through a head member of the fish hook apparatus from a top nose element to an opposing side wall of the head member, according to an embodiment herein;

FIG. 3 illustrates a top perspective view of the fish hook apparatus of FIG. 1, showing openings configured in the head member of the fish hook apparatus, according to an embodiment herein;

FIG. 4 illustrates an enlarged, front perspective view of the fish hook apparatus of FIG. 1, showing a fishing line of a fishing rod, passing through the openings configured in the head member of the fish hook apparatus, according to an embodiment herein;

FIG. 5A illustrates a front perspective view of the fish hook apparatus of FIG. 1, showing a bait attached to a bottom end of the head member, according to an embodiment herein;

FIG. 5B illustrates a front perspective view of a tail of the bait of the fish hook apparatus of FIG. 1, showing a securing element coupled to the tail of the bait, according to an embodiment herein;

FIG. 5C illustrates a front perspective view of the fish hook apparatus of FIG. 1, showing the bait attached to the bottom end of the head member and the fishing line coupled to the tail of the bait using the securing element, according to an embodiment herein;

FIGS. 6A-6E illustrate front perspective views of the fish hook apparatus of FIG. 1, showing a production of a controllable action in the bait attached to the fish hook apparatus, according to an embodiment herein;

FIG. 7 illustrates a method for producing a controllable action in a bait, according to an embodiment herein;

FIG. 8 illustrates an exemplary embodiment of the solution for a fishing lure that mimics a decapod crustacean, the exemplary embodiment comprised of a plastic lure, a double hook, and a tail securing element;

FIG. 9 is an underside view of an assembled embodiment of the fishing lure that mimics a decapod crustacean illustrated in FIG. 8;

FIG. 10 is an underside view of a fully rigged embodiment of the fishing lure that mimics a decapod crustacean illustrated in FIG. 8;

FIG. 11 is a topside view of a fully rigged embodiment of the fishing lure that mimics a decapod crustacean illustrated in FIG. 10, illustrating exemplary placement of an air pocket and a weight within the soft bait body and shown with the tail portion in an extended state;

FIG. 12 is a topside view of a fully rigged embodiment of the fishing lure that mimics a decapod crustacean illustrated in FIG. 10, illustrating exemplary placement of an air pocket and a weight within the soft bait body and shown with the tail portion in a curled state; and

FIG. 13 illustrates a series of movements of an exemplary embodiment of the solution for a fishing lure that mimics a decapod crustacean when rigged and in use.

### DETAILED DESCRIPTION

In the present description, the terms “eye” and “eyelet” are used interchangeably. An eye or eyelet may be associated with a hook or other component comprised within embodiments of a fishing lure embodiment according to the solution to provide a means and place for tying a fishing line and/or imparting a directional force to the hook or component.

In the present description, the term “worm” refers broadly to a family of soft plastic fishing baits generally comprised of a long, tubular body. Certain exemplary embodiments of the solution are configured to receive a “worm” styled plastic bait and manipulate its movement to create an action that resembles a real life worm.

In the present description, the term “decapod crustacean” refers broadly to any lifeform classified as a decapod crustacean, as well as lifeforms similar to decapod crustaceans in their natural movements, such as, but not limited to, crayfish (aka crawdads, crawfish, crawdaddies, etc.), shrimp, prawns, and lobsters. Certain exemplary embodiments of the solution comprise a lure body configured to resemble a decapod crustacean. Such lure bodies may be comprised of soft plastic, hard plastic, or a combination thereof.

In the present description, the term “plastic bait,” “soft plastic bait,” “soft bait” and the like refer to a class of lures understood in the art of fishing. Plastic baits are generally constructed from plastisol which is a a suspension of PVC (polyvynil chloride) or other polymer particles in a liquid plasticizer. Notably, a lure that falls within the classification of a “plastic bait,” or a lure system that comprises a “plastic bait” component (such as embodiments of the solution described herein), may not necessarily be constructed from plastisol, or entirely of plastisol, as other plastics (hard and soft alike) and materials may be comprised within the lure. As such, use of the term “plastic” in this description, whether as a noun or an adjective, will not be construed to limit the disclosure to embodiments constructed entirely of plastisol.

### Exemplary Embodiments of the Solution that Mimick a Worm

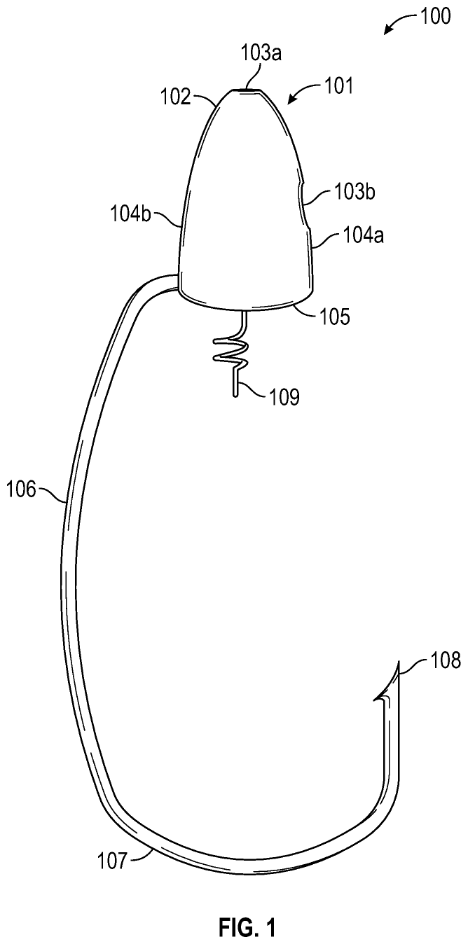

Turning now to the illustrations of FIGS. 1-7, exemplary embodiments of the solution that are configured to mimick the action and motion of a worm are shown and described.

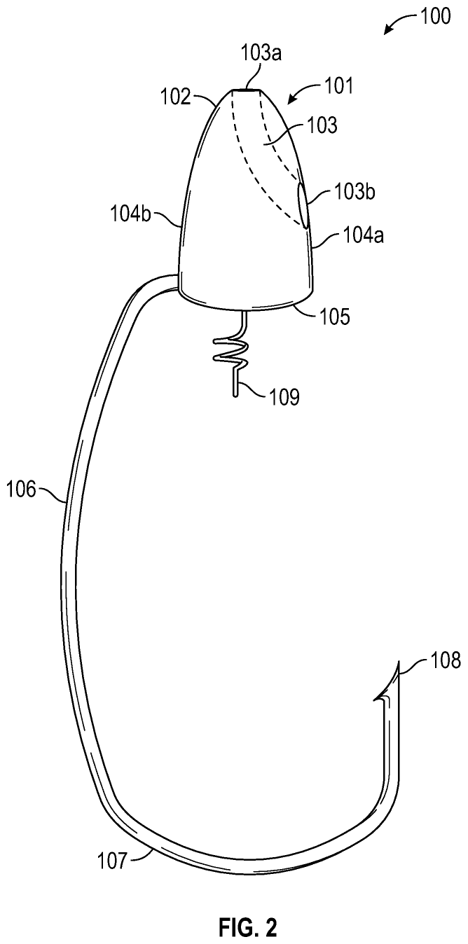

Beginning with FIG. 1, illustrated is a front elevation view of a fish hook apparatus 100, according to an embodiment herein. The fish hook apparatus 100 disclosed herein comprises a head member 101, a shank 106, a bend section 107, a point element 108, and securing elements 109 and 110 illustrated in FIGS. 1-2 and FIG. 5B respectively. The head member 101 is defined by a top nose element 102, opposing side walls 104a and 104b, and a bottom end 105. The head member 101 allows connection of a fishing line to the fish hook apparatus 100. The head member 101 is, for example, made of lead. The head member 101 comprises a channel 103 as illustrated in FIG. 2, configured to pass through the head member 101 from the top nose element 102 to one of the opposing side walls, for example, 104a, of the head member 101. In an embodiment, the channel 103 of the head member 101 comprises openings or holes, for example, a first opening 103a and a second opening 103b. The first opening 103a is configured at the top nose element 102. The first opening 103a is configured to receive a fishing line and pass the fishing line through the channel 103 and out through the second opening 103b. The second opening 103b is configured at the opposing side wall 104a. The second opening 103b is configured to receive and exit the fishing line passed through the channel 103. The shank 106 extends from the other opposing side wall 104b of the head member 101. In an embodiment, the shank 106 is molded to the head member 101. The shank 106 connects the bend section 107 to the head member 101. The bend section 107 extends from the shank 106. The bend section 107 is a curved portion of the fish hook apparatus 100. The point element 108 extends from the bend section 107 in an upward direction as illustrated in FIG. 1. The point element 108 is a sharp element configured to pierce a bait, for example, a soft plastic bait, a live worm, grub, etc.

A first securing element 109, for example, a screw-type fastener such as a screw-type hitchhiker, is coupled to the bottom end 105 of the head member 101. In an embodiment, the first securing element 109 is molded to the bottom end 105 of the head member 101. The first securing element 109 is configured to secure a head of the bait. In an embodiment, the first securing element 109 is configured as a screw lock bait keeper for attaching the bait to the fish hook apparatus 100. The first securing element 109 screws the head of the bait onto the fish hook apparatus 100. A second securing element 110, for example, a hook or another screw-type hitchhiker, is coupled or screwed to any one of multiple locations, for example, the body, the tail, etc., of the bait. The second securing element 110 is configured to secure one end of the fishing line exiting from the second opening 103b of the channel 103 of the head member 101 to the bait. The fish hook apparatus 100 disclosed herein allows a user of the fish hook apparatus 100, for example, an angler, to controllably tug the fishing line to curl the bait secured by the first securing element 109 and the second securing element 110 backwards towards the head member 101 and to spring the bait forwards due to tension in the bait to produce a controllable action, for example, a curling, worm-like action, in the bait. The fish hook apparatus 100 disclosed herein allows the angler to produce a controllable action, for example, a curling, worm-like action, in the bait in a strike zone of a water body without reeling the bait out of the strike zone.

FIG. 2 illustrates a front perspective view of the fish hook apparatus 100, showing a channel 103 configured to pass through the head member 101 of the fish hook apparatus 100 from the top nose element 102 to the opposing side wall 104a of the head member 101, according to an embodiment herein. The channel 103 is configured within the head member 101 and extends from the opening 103a in the top nose element 102 to the opening 103b in the opposing side wall 104a. The channel 103, therefore, passes through the top nose element 102 and out through the opposing side wall 104a of the head member 101. The channel 103 allows a fishing line to be fed through the top nose element 102 and out the opposing side wall 104a of the head member 101. That is, the channel 103 allows the fishing line received through the opening 103a in the top nose element 102 of the head member 101 to pass through and exit from the opening 103b at the opposing side wall 104a of the head member 101.

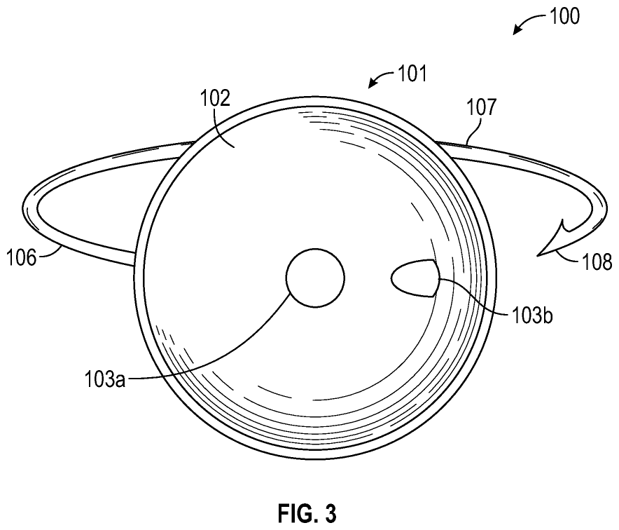

FIG. 3 illustrates a top perspective view of the fish hook apparatus 100, showing the openings 103a and 103b configured in the head member 101 of the fish hook apparatus 100, according to an embodiment herein. The opening 103a is configured at the top nose element 102 and the opening 103b is configured at the opposing side wall 104a of the head member 101 as illustrated in FIGS. 1-2. An angler inserts one end of the fishing line through the opening 103a in the top nose element 102. The opening 103a in the top nose element 102 receives the fishing line and passes the fishing line through the channel 103 illustrated in FIG. 2 and out through the other opening 103b. The opening 103b at the opposing side wall 104a of the head member 101 receives and exits the fishing line passed through the channel 103.

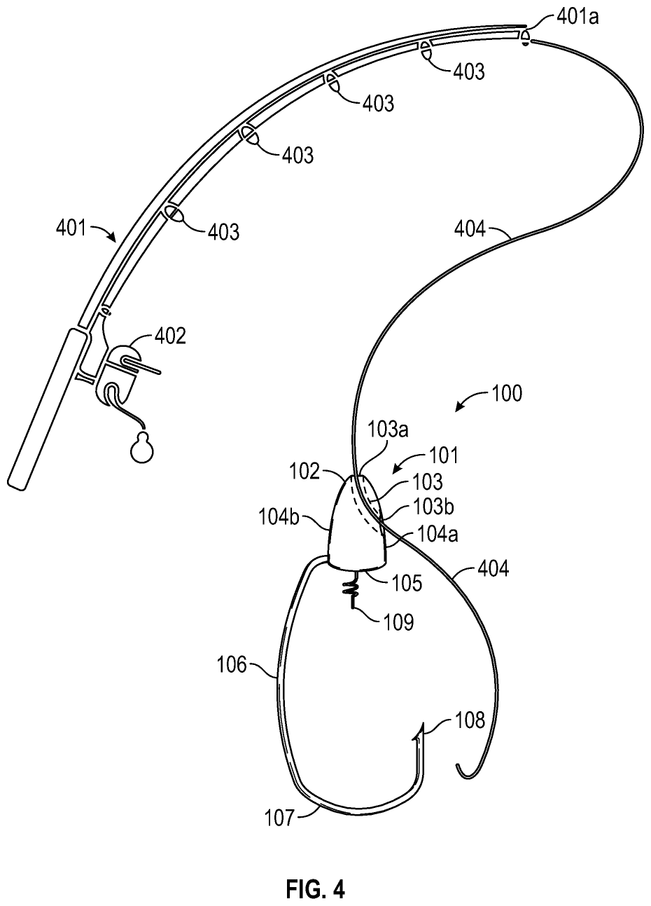

FIG. 4 illustrates an enlarged, front perspective view of the fish hook apparatus 100, showing a fishing line 404 of a fishing rod 401, passing through the openings 103a and 103b configured in the head member 101 of the fish hook apparatus 100, according to an embodiment herein. The fishing rod 401 comprises a reel 402 and guides 403. The guides 403 run the length of the fishing rod 401 and guide the fishing line 404 from the reel 402 to a tip 401a of the fishing rod 401. The reel 402 contains a spool of the fishing line 404. Using a button or another element positioned on the reel 402, an angler releases the fishing line 404 from the reel 402 and passes the fishing line 404 through the guides 403 until the fishing line 404 extends from the tip 401a of the fishing rod 401. The angler then inserts one end of the fishing line 404 into the opening 103a at the top nose element 102 of the head member 101 and passes the fishing line 404 through the channel 103 towards the opening 103b on the opposing side wall 104a of the head member 101. The channel 103 allows the fishing line 404 to feed through the top nose element 102 and out the opposing side wall 104a of the head member 101.

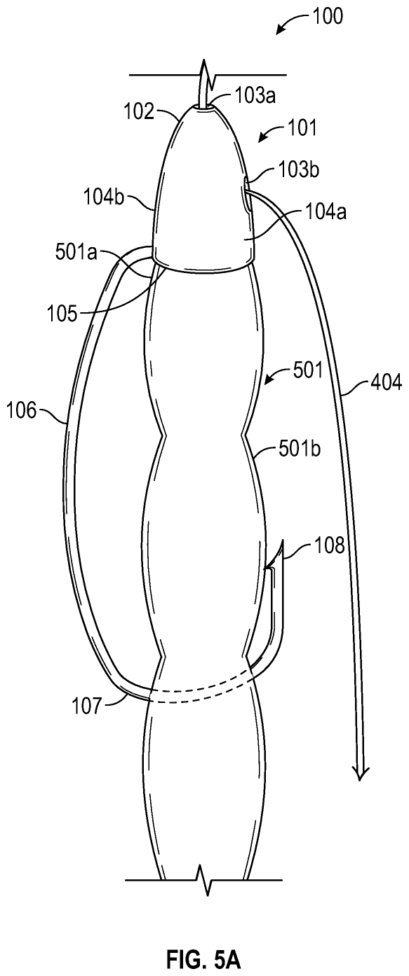

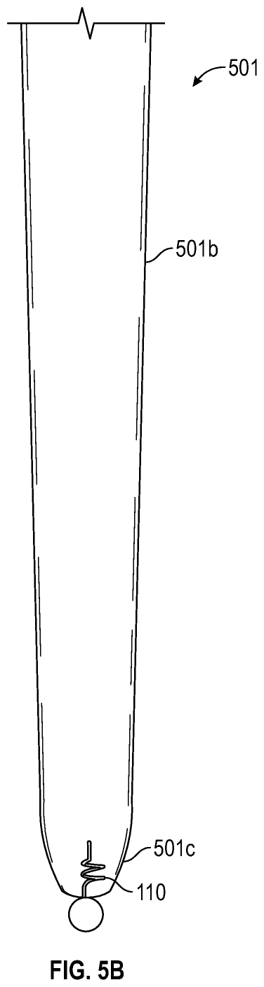

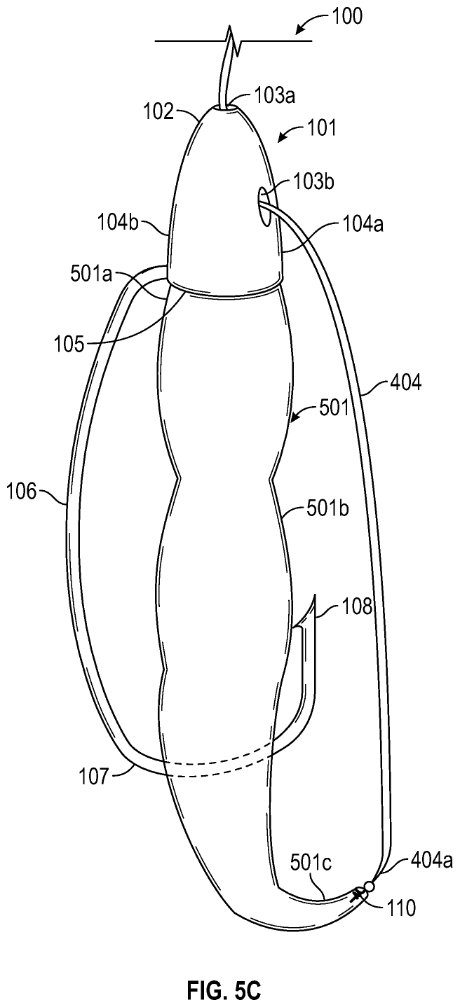

FIG. 5A illustrates a front perspective view of the fish hook apparatus 100, showing a bait 501 attached to a bottom end 105 of the head member 101, according to an embodiment herein. FIG. 5A also illustrates the fishing line 404 passing through the openings 103a and 103b configured in the head member 101, according to an embodiment herein. In an embodiment, the bait 501 used for attracting fish comprises a head 501a, a body 501b, and a tail 501c. FIG. 5B illustrates a front perspective view of the tail 501c of the bait 501, showing a securing element 110, for example, a hook, coupled to the tail 501c of the bait 501, according to an embodiment herein.

FIG. 5C illustrates a front perspective view of the fish hook apparatus 100, showing the bait 501 attached to the bottom end 105 of the head member 101 and the fishing line 404 coupled to the tail 501c of the bait 501 using the securing element 110, according to an embodiment herein. In an embodiment, the securing element 109 illustrated in FIG. 4, extends from the bottom end 105 of the head member 101. The securing element 109 is, for example, a screw-type fastener such as a screw-type hitchhiker as illustrated in FIG. 4. The screw-type hitchhiker is a spring-type device. The head 501a of the bait 501 is screwed and fastened to the head member 101 via the securing element 109. The securing element 109 secures the head 501a of the bait 501. The end 404a of the fishing line 404 that exits the opening 103b in the opposing side wall 104a of the head member 101 is coupled to the securing element 110 that is coupled to the tail 501c of the bait 501. The securing element 110, therefore, couples the end 404a of the fishing line 404 to the tail 501c of the bait 501. In an embodiment, the securing element 110 is attached to the end 404a of the fishing line 404 and hooked or screwed into the tail 501c of the bait 501. In an embodiment (not shown), the fishing line 404 is coupled to any part of the body 501b of the bait 501 using the securing element 110.

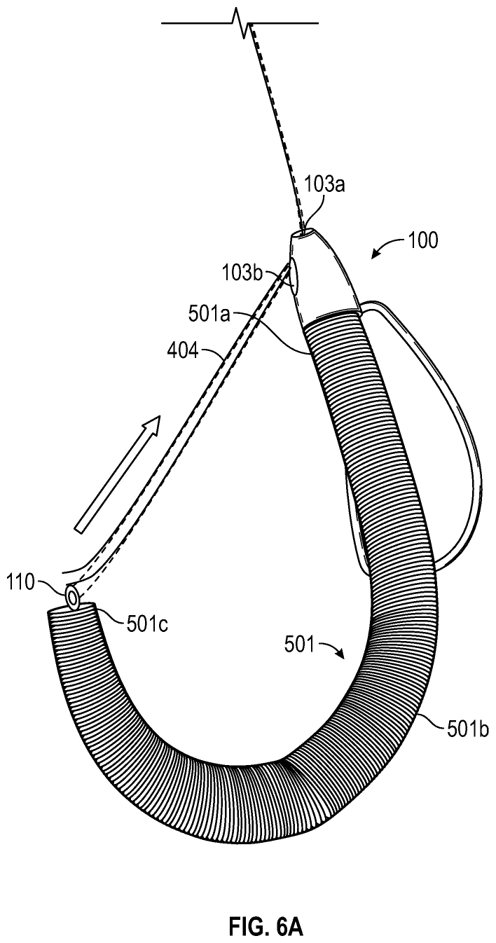

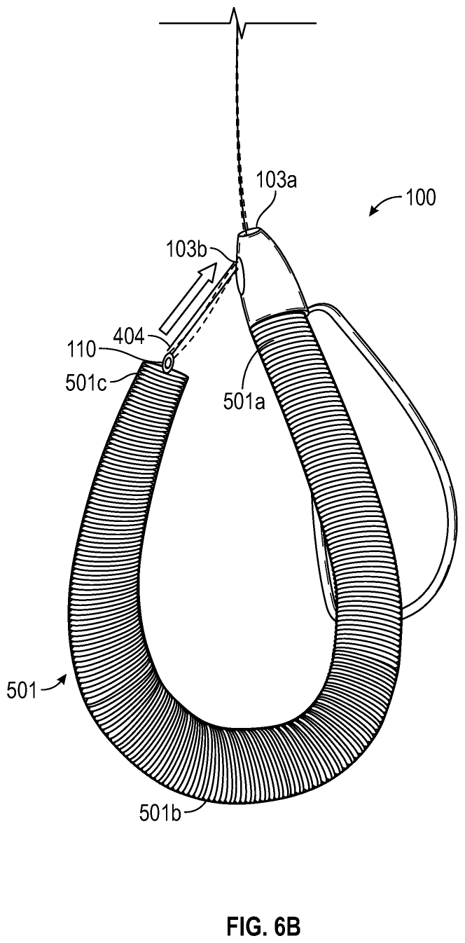

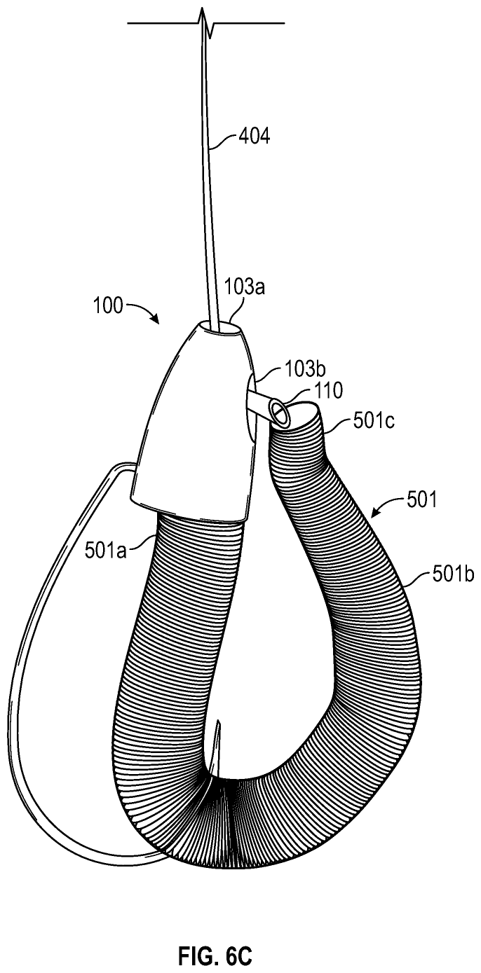

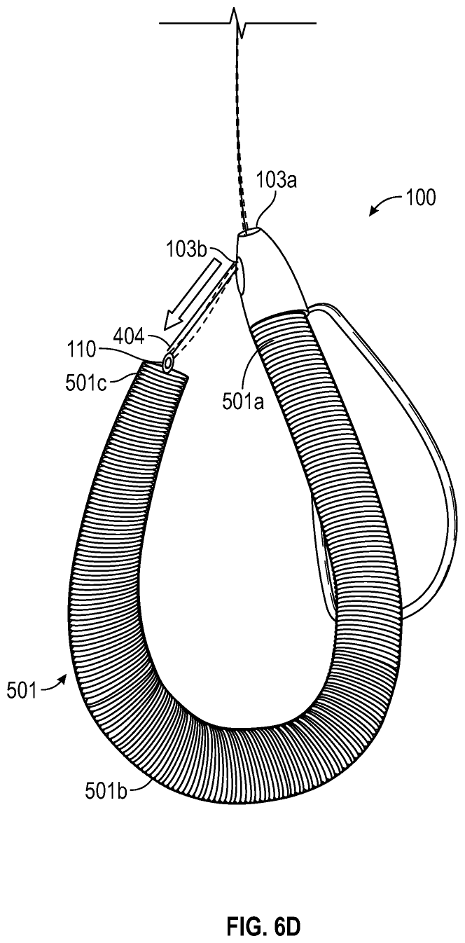

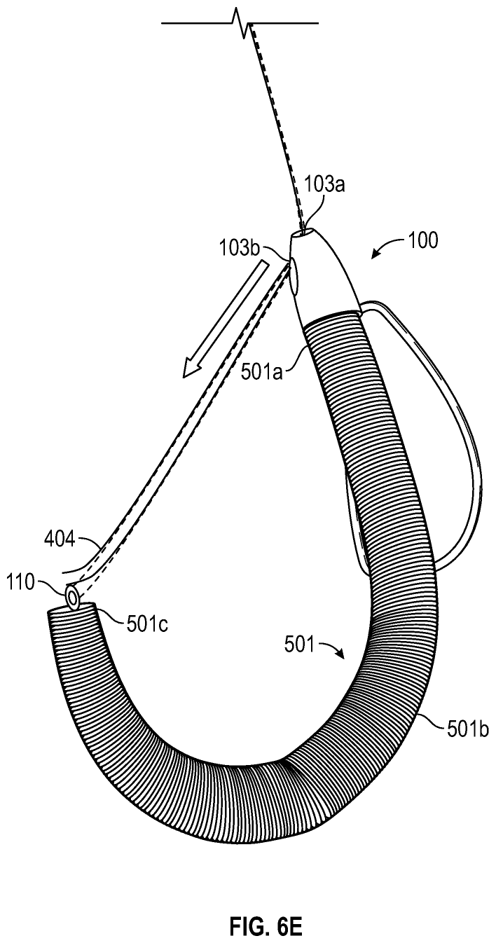

FIGS. 6A-6E illustrates front perspective views of the fish hook apparatus 100, showing a production of a controllable action in the bait 501 attached to the fish hook apparatus 100, according to an embodiment herein. An angler controllably tugs the fishing line 404 to curl the bait 501 secured by the securing elements 109 and 110 backwards towards the head member 101 as illustrated in FIGS. 6A-6C, and to spring the bait 501 forwards due to tension in the bait 501 as illustrated in FIGS. 6D-6E, to produce a controllable action, for example, a curling, worm-like action, in the bait 501. When the tip 401a of the fishing rod 401 illustrated in FIG. 4 is tugged, the bait 501 curls back up to the head member 101 as illustrated in FIG. 6C. For purposes of illustration, the detailed description refers to production of a curling, worm-like action using the fish hook apparatus 100 and the fishing line 404; however the scope of the fish hook apparatus 100 and the method disclosed herein is not limited to production of a curling, worm-like action but may be extended to implement production of any type of controllable action that attracts the attention of fish.

In the fish hook apparatus 100 disclosed herein, the fishing line 404 passes through the head member 101 and not through any eye element. The fish hook apparatus 100 disclosed herein is free of the eye element to which a fishing line is typically tied. In the fish hook apparatus 100 disclosed herein, the fishing line 404 is fed through the head member 101 via the channel 103 and tied to the securing element 110, which is inserted into the tail 501c of the bait 501. Tying the fishing line 404 to the tail 501c or another part of the bait 501 via the securing element 110 allows creation of a realistic action in the bait 501. When the angler slightly tugs the tip 401a of the fishing rod 401, the tail 501c of the bait 501 curls up towards the top nose element 102 of the head member 101, thereby creating a realistic curling action of a live worm in the bait 501. The fish hook apparatus 100 provides the angler with complete control of how and when the bait 501 curls.

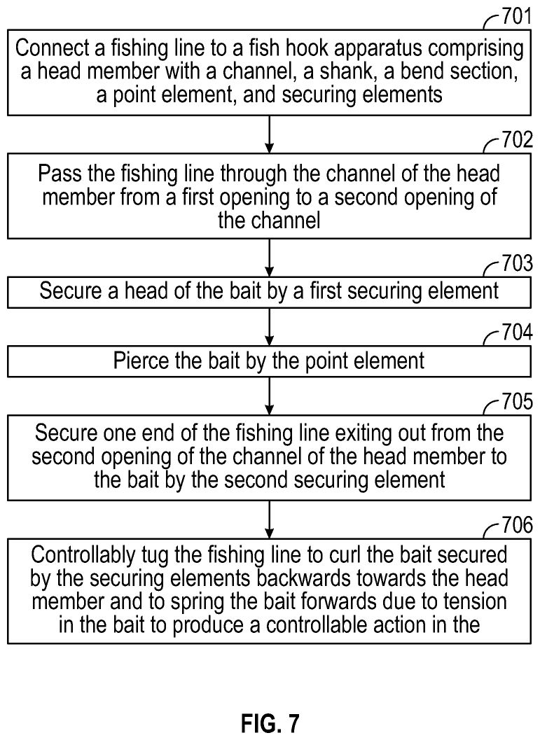

FIG. 7 illustrates a method for producing a controllable action in a bait, according to an embodiment herein. A user, for example, an angler, connects 701 a fishing line to the fish hook apparatus 100 and passes 702 the fishing line through the channel of the head member from the first opening to the second opening as illustrated in FIG. 4. The angler then secures 703 the head of the bait using a securing element as illustrated in FIG. 5A. The angler then pierces 704 the body of the bait using the point element as illustrated in FIG. 5A and FIG. 5C. The angler then secures 705 one end of the fishing line exiting from the second opening of the channel of the head member using another securing element as illustrated in FIG. 5C. The angler then controllably tugs 706 the fishing line to curl the bait secured by the securing elements backwards towards the head member and to spring the bait forwards due to tension in the bait to produce a controllable action, for example, a curling, worm-like action in the bait as illustrated in FIGS. 6A-6E.

The fish hook apparatus and the method disclosed herein creates a fishing lure where the fishing line passes through the head member and attaches to the middle or tail of the bait. The fish hook apparatus disclosed herein allows an angler to be able to create an action in the bait without having to reel in their bait. The angler may slightly tug on the tip of the fishing rod, which makes the body or the tail of the bait move back and forth to produce a substantial action out of the bait, thereby allowing the angler to leave the bait in a particular area and move or provide action to the bait without having to reel in the bait. The angler may, therefore, leave the bait in the strike zone while the bait is moving. The fish hook apparatus disclosed herein is, therefore, useful in the fishing industry. Moreover, the fish hook apparatus provides the bait, for example, a worm or grub, with a realistic curl action rather than merely reeling or pulling the bait through the water. Furthermore, the fish hook apparatus allows the angler to have full and total control of how and when the bait acts or curls.

### Exemplary Embodiments of the Solution that Mimick a Decapod Crustacean

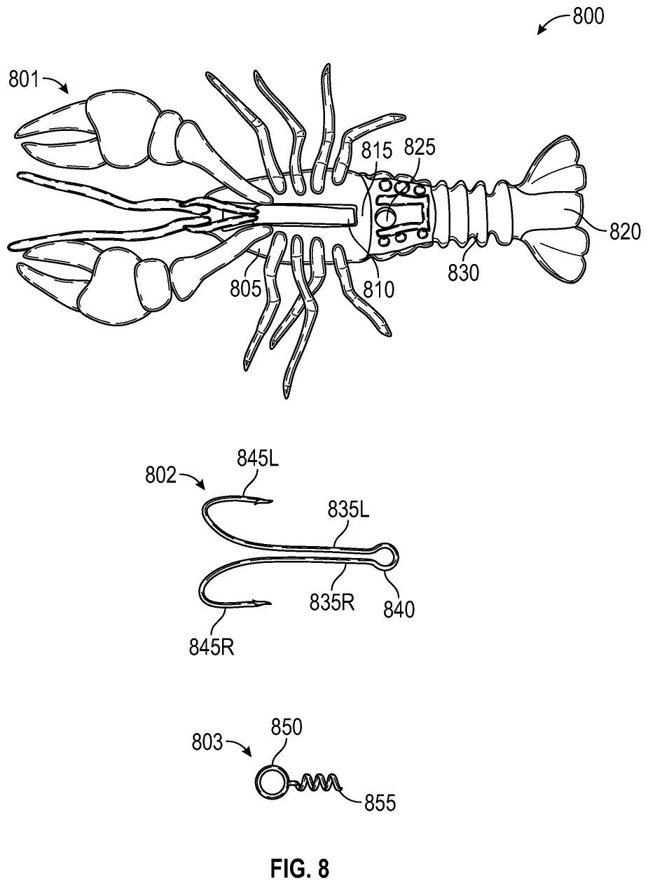

Turning now to the illustrations of FIGS. 8-13, exemplary embodiments of the solution that are configured to mimick the action and motion of a decapod crustacean are shown and described.

Beginning with FIG. 8, illustrated is an exemplary embodiment 800 of the solution for a fishing lure that mimics a decapod crustacean, the exemplary embodiment 800 comprised of a plastic lure 801, a double hook 802, and a tail securing element 803. The exemplary plastic lure 801 provided in the illustration is in the form of a particular decapod crustacean known as a crayfish or, colloquially, a crawdad or crawfish. Other forms of decapod crustaceans are envisioned as the plastic lure component for other embodiments of the solution.

The plastic lure 801 is comprised of a main body portion 805 and a tail portion 820 communicatively coupled via a hinge 830. For ease of description, the plastic lure 801 is referred to herein as being comprised of a main body portion 805 and a tail portion 820 connected by a hinge 830. One of ordinary skill in the art of marine biology reviewing this description and the figures, however, will understand that the main body portion 805 of the plastic lure 801 may generally represent the cephalothorax (a head, carapace, legs, cheliped or “claws”, etc.) and tergum portion of the abdomen of a decapod crustacean. Moreover, the hinge 830 may be incorporated into the representative tergum portion. The tail portion 820 represents that part of a decapod crustacean's anatomy that a marine biologist may refer to as the telson and/or uropod.

Returning now to the figure, in a preferred embodiment the hinge 830 may essentially be a “narrow” or relatively “thin” section of plastic that couples the carapace of the main body portion 805 at the tergum to the tail 820 (such as that which is illustrated in the figure), although it is envisioned that in other embodiments the hinge 830 may comprise mechanical hinge elements like a barrel hinge or piano hinge. It is further envisioned that embodiments of the solution may incorporate a compression spring element in the tergum area of the main body portion 805 that biases the tail 820 to its extended state. Regardless, the hinge 830 may be configured to bias the tail 820 to an extended state such that, when the fishing line is relaxed, the hinge 830 has a bias to return the tail 820 to its default state of extension, as will be better understood from a review of the description and figures that follow.

Returning to the main body portion 805 of the plastic lure 801, a hook shank channel 810 may be incorporated into the underside of the main body portion 805 in association with the carapace. As will become clearer from a review of the figures and description that follows, the hook component (e.g., double hook 802) may be retained in the hook shank channel 810 when the embodiment 800 is assembled and ready to be rigged. At the end of the hook shank channel 810 that is proximate to the hinge 830 (i.e. the end proximate to the tergum), the exemplary embodiment includes a hook retention element 815 in the form of a bridge of plastic that spans across the hook shank channel 810. The benefit of the hook retention element 815 will become clearer from a review of the figures and illustrations that follow.

A vertical channel 825 with an entry aperture on the topside of the tergum and an exit aperture on the bottom side of the tergum is located between the hook shank channel 810 and the hinge 830. The function and purpose of the channel 825 will become evident from a review of the descriptions and illustrations that follow. The hook component 802 is in the form of a double hook having a mirrored pair of hooks 845L, 845R respectively associated with shanks 835L, 835R. The shanks 835L, 835R collectively define a common shank 835 for the double hook 802 and work together to form a common eyelet 840.

A tail securing element 803 is a separate component from the plastic lure 801 and hook component 802. The tail securing element 803 is comprised of its own eyelet 850 and an anchor aspect 855 that enables the tail securing element 803 to be mechanically received by and held into the tail portion 820 of the plastic lure 801, as will become clearer from a review of the description and figures that follow. In the exemplary embodiment of a tail securing element 803 illustrated in the figures, the anchor aspect 855 is in the form of a corkscrew, however, it is envisioned that structures other than a corkscrew such as, but not limited to, a barbed shaft or a hook may be incorporated by a tail securing element 803 without departing from the scope of the solution.

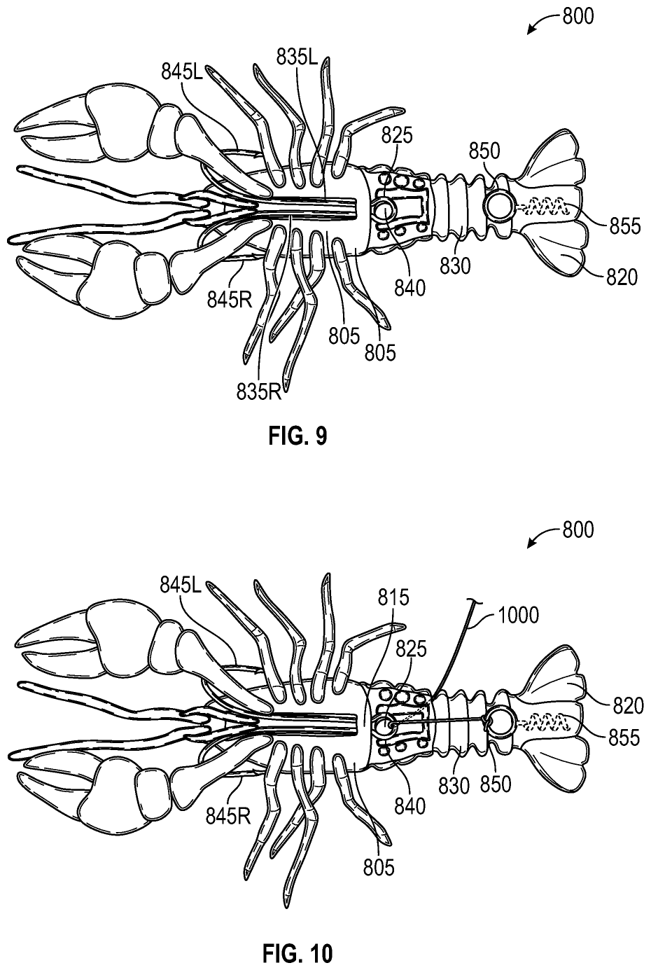

FIG. 9 and the figures that follow will be described with reference back to the description of the FIG. 8 illustration. FIG. 9 is an underside view of an assembled embodiment 800 of the fishing lure that mimics a decapod crustacean illustrated in FIG. 8. As can be understood from the FIG. 9 illustration, the tail securing element 803 has been installed into the tail portion 820 of the plastic lure 801 by virtue of the corkscrew anchor aspect 855 being “screwed” into the plastic of the tail portion 820. In this way, the eyelet 850 of the tail securing element 803 is exposed on the underside of the tail portion 820. The shank 835 of the hook component 802 has been received into the hook shank channel 810 and under the hook retention element 815 such that the eyelet 840 of the hook component 802 is substantially aligned with the exit aperture of the channel 825 that extends substantially vertically through the tergum of the main body portion 805 at a location somewhere between the carapace and the hinge 830. The hooks 845 are positioned proximate to the head of the main body portion 805. Advantageously, the hook shank channel 810 and/or the hook retention element 815 may be sized such that the hook shank 835 is a “compression fit” into the channel 810 and under the retention feature 815. In this way, once the lure 800 is assembled and/or rigged, the hook component 802 may be biased to stay coupled to the main body portion 801 of the plastic lure without “flopping” or decoupling from the main body portion in a manner that would negatively affect the presentation of the lure to a fish.

FIG. 10 is an underside view of a fully rigged embodiment 800 of the fishing lure that mimics a decapod crustacean illustrated in FIG. 8. The illustration in FIG. 10 demonstrates the fishing lure in an assembled state (such as has been described relative to the FIG. 9 illustration) and rigged for fishing. As can be understood from the FIG. 10 illustration, a fishing line 1000 has been strung down through the channel 825 from the aperture on the topside of the tergum and out of the aperture on the underside of the tergum. In this way, the fishing line also runs through the eyelet 840 of the hook component 802. Notably, the fishing line 1000 is terminated with a knot at the eyelet 850 of the tail securing element 803. The fully rigged fishing lure 800 is now ready to be fished. The advantageous motion and action that comes from application of the fully rigged fishing lure 800 as shown in the FIG. 10 illustration will become clear from a review of the description and illustrations that follow.

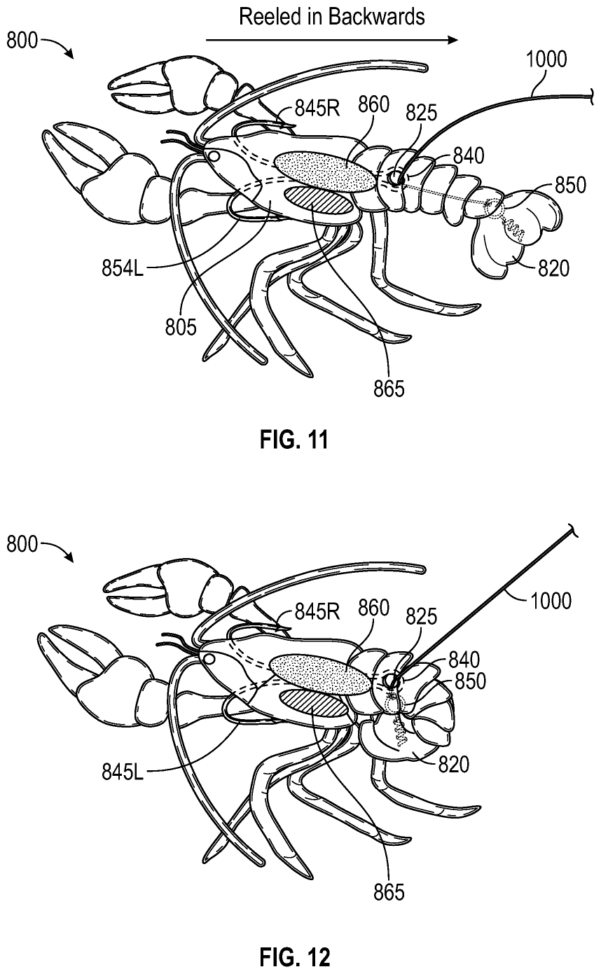

FIG. 11 is a topside view of a fully rigged embodiment of the fishing lure 800 that mimics a decapod crustacean illustrated in FIG. 10, illustrating exemplary placement of an air pocket 860 and a weight 865 within the carapace of the soft bait body 805 and shown with the tail portion 820 in an extended state. Advantageously, certain embodiments of the solution may incorporate an air pocket 860 and/or an internal weight 865 in order to create a bias for the entire lure 800 to sink in water. As one of ordinary skill in the art would recognize, the size of the air pocket 860 relative to the mass of the weight 865 may encourage the lure 800 to fall or sink at a desired rate or enable the lure 800 to be fished at certain depths. In some embodiments, a weight 865 may be incorporated into the plastic lure 801 without a corresponding air pocket 860 and vice versa. Moreover, some embodiments of the solution may not incorporate either of an air pocket or a weight. Still other embodiments may incorporate an air pocket and/or a weight in some other location or manner than that which is illustrated in the exemplary FIG. 11 illustration such as, for example, by constructing the claws of the fishing lure out of a weighted material.

Returning to the FIG. 11 illustration, the fishing line 1000 is not under tension and has been allowed to “slack.” In this way, relatively little or no pulling force is being imparted to the lure system 800 by the fishing line 1000, as depicted in the FIG. 11 illustration. With the fishing line 1000 in a slack state, the tergum and tail portion 820 of the plastic bait 801 are in an extended state. Notably, the plastic bait 801 may be molded such that the tergum and tail portion 820 are biased to the extended state, i.e., the tail portion 820 being normally extended.

FIG. 12 is a topside view of a fully rigged embodiment of the fishing lure 800 that mimics a decapod crustacean illustrated in FIG. 10, illustrating exemplary placement of an air pocket 860 and a weight 865 within the soft bait body 805 and shown with the tail portion 820 in a curled state. As compared to the FIG. 11 illustration, in the FIG. 12 illustration the fishing line 1000 is under tension (i.e., the fisherman may be “pulling” the line 1000). Advantageously, when the fishing line 1000 is pulled, the hinge 830 provides for the tail portion 820 to be curled forward and towards the main body portion 805 (into a curled state), bringing the eyelet 850 of the tail securing element 803 towards the eyelet 840 of the hook component 802 while the entire lure 800 is pulled in an opposite direction associated with the directional force imparted by the fishing line 1000. Put more simply, the entire lure 800 is “reeled in backwards” (as represented by the directional arrow in the FIG. 11 illustration) even as the tail portion 820 is curled forwards and underneath. This action and motion of the lure system accurately, and advantageously, mimicks the lifelike motion of a swimming decapod crustacean.

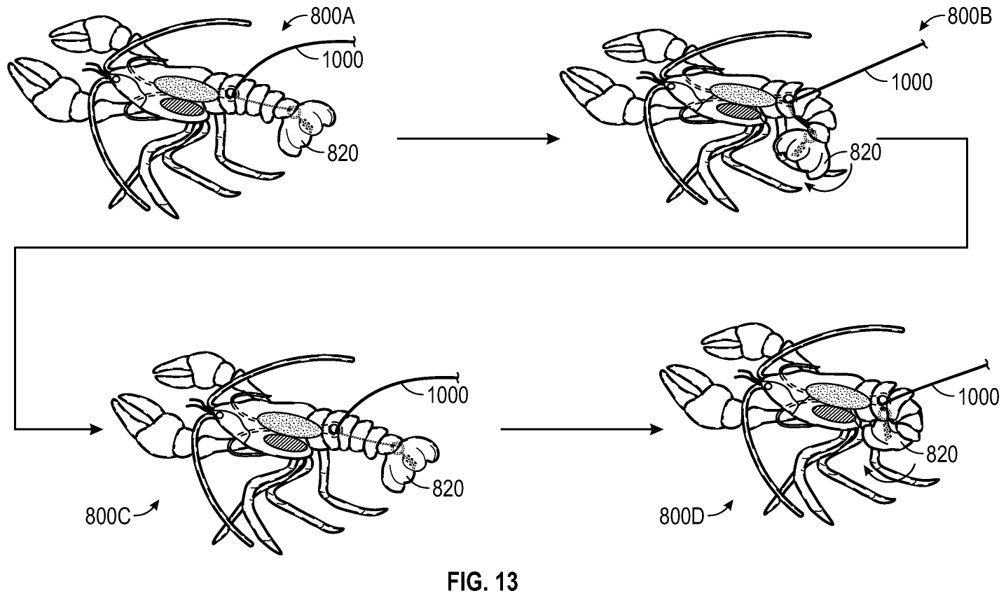

FIG. 13 illustrates a series of movements of an exemplary embodiment of the solution for a fishing lure 800 that mimics a decapod crustacean when rigged and in use. Consistent with that which has been previously described, the FIG. 13 illustration demonstrates an exemplary embodiment of the solution 800 as it is “fished” and transitioned between its extended and curled states. Beginning with 800A, the fishing line 1000 is in a slack state such that the tail portion 820 is in its normal, extended state. In association with 800A, the weight 865 may urge the lure to settle or sink. As the fishing line 1000 is pulled, the lure transitions from the extended state to the curled state as illustrated in 800B, with the entire lure being moved in the direction dictated by the pulled fishing line 1000. The tail portion 820 curls underneath and toward the head of the lure. The lure may at the same time be raised in the water. A subsequent relaxing of the fishing line 1000 as shown in 800C allows the lure to fall in the water (as may be encouraged by the balance of the weight 865 with the air pocket 860) as the tail portion 820 regains its extended state. Imparting a modest pulled force on the fishing line 1000 again may return the lure to the curled state (800B). Advantageously, by sequentially pulling the fishing line 1000 and allowing it to relax or go slack, it can be understood that the lure will transition back and forth between the curled and extended states as the lure rises and falls in the water on its path back towards the fisherman. The illustration of 800D demonstrates the result of a significant pull on the fishing line 1000 that causes the tail portion 820 to aggressively curl towards the main body portion 805 such that the eyelet 850 of the tail securing element 803 is “jammed” into and stopped by the eyelet 840 of the hook component 802. A fisherman may impart a significant pulling force on the fishing line 1000 in the manner illustrated by 800D (and FIG. 12) when a fish strike on the lure is detected. In this way, the hook component 802 may be aggressively pulled by virtue of the fishing line 1000 imparting a pulling force on the eyelet 850 which in turn imparts a pulling force on the the hook component eyelet 840 which, in turn, causes the hooks 845 to set into the striking fish. With the hooks 845 set into the fish, the fish may be caught by reeling in the fishing line 1000.

The foregoing examples and illustrative implementations of various embodiments have been provided merely for explanation and are in no way to be construed as limiting of the embodiments disclosed herein. For ease of reading and understanding, the disclosure has been divided into embodiments of the solution directed to a worm and embodiments of the solution directed to a decapod crustacean; however, it will be understood that any portion or portions of the entire disclosure may be applicable to a given embodiment of the solution and, therefore, any description, suggestion or teaching offered herein within the context of a worm-like embodiment may be applicable to an embodiment of the solution directed to a decapod crustacean and vice versa. Additionally, while the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be executed and changes may be made thereto, without departing from the scope and spirit of the embodiments disclosed herein.

What is claimed is:

1. A fishing lure system comprising:
a soft bait component defining a head end, a body portion, and a tail end, wherein the tail end is configured to transition between an extended state and a curled state such that when the tail end is transitioned to the curled state a distal-most portion of the tail end moves toward the head end;
a channel through the tail end, the channel defined by an upper aperture associated with an upper surface of the tail end and a lower aperture associated with a lower surface of the tail end;
a hook component comprising an eyelet, a shank, a bend section, and a point element, wherein the eyelet is substantially aligned with the channel; and
a securing element comprising an eyelet, wherein a diameter of the securing element eyelet exceeds a diameter of the hook component eyelet;
wherein when:
the securing element is secured to the lower surface of the tail end of the soft bait component, and
a fishing line is extended through the channel from the upper aperture to the lower aperture and secured to the eyelet of the securing element,
a pulling force applied to the fishing line by an angler will cause the tail end to transition from the extended state to the curled state while the entire fishing lure system is pulled in a direction toward the angler, and release of the pulling force will allow the tail end to transition from the curled state back to the extended state.

2. The fishing lure system of claim 1, wherein an aggressive pulling force applied to the fishing line will cause the securing element eyelet to be received by, and mechanically stopped by, the lower aperture and/or the hook component eyelet.

3. The fishing lure system of claim 1, wherein the hook component comprises two or more point elements.

4. The fishing lure system of claim 1, wherein the soft bait component is configured to resemble a decapod crustacean.

5. The fishing lure system of claim 4, wherein the decapod crustacean is one of a crayfish, shrimp, prawn, and lobster.

6. The fishing lure system of claim 1, wherein the soft bait component comprises a soft plastic.

7. The fishing lure system of claim 6, wherein the soft bait component further comprises one or more portions of hard plastic.

8. The fishing lure system of claim 1, wherein the soft bait component comprises a gas-filled chamber for creating buoyancy.

9. The fishing lure system of claim 8, wherein an amount of gas in the gas-filled chamber is adjustable.

10. The fishing lure system of claim 1, wherein the soft bait component comprises a weight component for causing the system to have an overall density greater than water.

11. The fishing lure system of claim 10, wherein the weight component comprises one or more of lead, tin, tungsten, bismuth, steel, and a metal alloy.

12. The fishing lure system of claim 1, wherein the soft bait component comprises a gas-filled void and a weight component that are calibrated to generate an overall density of the fishing lure system configured to cause the system to fall through water at a controlled rate.

13. The fishing lure system of claim 12, wherein the weight component comprises one or more of lead, tin, tungsten, bismuth, steel, and a metal alloy.

14. The fishing lure system of claim 12, wherein an amount of gas in the gas-filled chamber is adjustable.

15. The fishing lure system of claim 1, wherein at least one of the upper aperture and lower aperture is defined by a grommet component.

16. The fishing lure system of claim 1, wherein the securing element is integral to the tail end of the soft bait component.

17. The fishing lure system of claim 1, wherein the securing element comprises a corkscrew-type fastener and is removably fixed to the tail end of the soft bait component.

18. The fishing lure system of claim 1, wherein the point element of the hook comprises a barb.

19. The fishing lure system of claim 1, further comprising a scent chamber in the soft bait component for containing a releasable scent substance.

20. The fishing lure system of claim 1, wherein the soft body component comprises a shank channel for receiving the shank of the hook component and a shank retention aspect for retaining the shank of the hook component in the shank channel.
